(19) United States
(12) Patent Application Publication
(10) Pub. No.: US 2025/0048242 A1
(43) Pub. Date: Feb. 6, 2025

(54) ENFORCING NETWORK SLICE SIMULTANEOUS REGISTRATION GROUP (NSSRG) IN EVOLVED PACKET SYSTEM (EPS) IN A WIRELESS COMMUNICATION SYSTEM

(71) Applicant: Samsung Electronics Co., Ltd., Suwon-si, Gyeonggi-do (KR)

(72) Inventors: Ashok Kumar NAYAK, Bangalore (IN); Varini GUPTA, Bangalore (IN)

(21) Appl. No.: 18/718,246

(22) PCT Filed: Jan. 11, 2023
(86) PCT No.: PCT/KR2023/000466

§ 371 Date: Jun. 10, 2024

(30) Foreign Application Priority Data
Jan. 11, 2022 (IN) 202241001345
Mar. 24, 2022 (IN) 202241016710
Dec. 22, 2022 (IN) 202241001345

(51) Int. Cl. H04W 48/18; H04W 48/16

(52) U.S. Cl. CPC H04W 48/18; H04W 48/16

(57) ABSTRACT

The disclosure relates to a 5G or 6G communication system for supporting a higher data transmission rate. Embodiments herein provide method for enforcing NSSRG in EPS by first network entity. The method includes receiving a PDN connection request with APN from UE. The method includes detecting whether any earlier PDN connection for UE is being handled by the first network entity or at least one second network entity. In an embodiment, when earlier PDN connection for the UE is handled by first network entity or the second network entity, the method includes applying NSSRG information for the PDN connection, selecting a S-NSSAI from a plurality of S-NSSAIs that is compatible to a S-NSSAI having same NSSRG information from the plurality of S-NSSAIs used to handle the earlier PDN connection by the network entity, and allocating the selected S-NSSAI to the UE to establish the PDN connection with the APN using allocated S-NSSAI.

### TECHNICAL FIELD

The disclosure relates to a wireless communication system (or, a mobile communication system). More particularly, the disclosure relates to a system and method to enforce Network Slice Simultaneous Registration Group (NSSRG) in an Evolved Packet System (EPS) when different combined Session Management Function (SMF)+Packet Data Network Gateway (PGW) (SMF+PGW-Cs) are used to address multiple packet data network (PDN) connections for a User Equipment (UE).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The principal object of the embodiments herein is to provide a method and a network entity for enforcing Network Slice Simultaneous Registration Group (NSSRG) in an Evolved Packet System (EPS).

Another object of the embodiments herein is enforce the NSSRG in the EPS for multiple Combined GW used for Evolved Packet Core (EPC) Session Management Function (SMF)+Packet Data Network Gateway (PGW)-Cs. The proposed method solves the issue which occurs during multiple PDN Connections initiated by a User Equipment (UE) by defining the SMF+PGW-C behaviour.

### Solution to Problem

Accordingly, the embodiment herein is to provide a method for enforcing Network Slice Simultaneous Registration Group (NSSRG) in an Evolved Packet System (EPS). The method includes receiving, by a first network entity, a packet data network (PDN) connection request with an access point network (APN) from a User Equipment (UE). Further, the method includes detecting, by the first network entity, whether any earlier PDN connection for the UE is being handled by the first network entity or at least one second network entity. In an embodiment, when the earlier PDN connection for the UE is handled by the first network entity or the at least one second network entity, the method includes applying NSSRG information for the PDN connection; selecting a Single-Network Slice Selection Assistance Information (S-NSSAI) from a plurality of S-NSSAIs that is compatible to a S-NSSAI having same NSSRG information from the plurality of S-NSSAIs used to handle the earlier PDN connection by the first network entity or the at least one second network entity; and allocating the selected S-NSSAI to the UE to establish the PDN connection with the APN using the allocated S-NSSAI. In another embodiment, when the earlier PDN connection for the UE is not handled with the first network entity or the at least one second network entity, the method includes applying NSSRG information for the requested PDN connection; selecting a S-NSSAI from a plurality of S-NSSAIs; and allocating the selected S-NSSAI to the UE to establish the PDN connection with the APN using the allocated S-NSSAI.

In an embodiment, the method includes sending, by at least one of the first network entity and the at least one second network entity, the PDU session ID and associated S-NSSAI associated with the PDN connection to a Unified data management (UDM) after PDN connection is established successfully.

In an embodiment, the first network entity is a session management function (SMF) Packet Data Network Gateway-Controller and the second network entity is a second SMF Packet Data Network Gateway-Controller.

In an embodiment, the selected S-NSSAI is associated with same NSSRG information from a plurality of NSSRGs provided in the NSSRG information.

In an embodiment, allocating the selected S-NSSAI to the UE includes sending a NAS message comprising the selected S-NSSAI associated to the UE to establish the PDN connection with the APN using the allocated S-NSSAI.

In an embodiment, detecting, by the first network entity, whether any of the earlier PDN connection for the UE is handled by the first network entity or the at least one second network entity includes checking, by the first network entity, whether the earlier PDN connection of the UE is associated with the first network entity based on a session management context stored at the first network entity, determining, by the first network entity, that the earlier PDN connection of the UE is not associated with the first network entity, sending, by the first network entity, a request message to a UDM entity for PDN connection information of the UE associated with the at least one second network entity, receiving, by the first network entity, the PDN connection information from the UDM for PDN connection information of the UE associated with the at least one second network entity, and detecting, by the first network entity, whether the earlier PDN connection of the UE is associated with the at least one second network entity when the received PDN connection information comprises PDU session identifier (ID) associated with the UE and corresponding S-NSSAI used by the at least one second network entity to establish the earlier PDN connection with the UE.

In an embodiment, the method includes sending, by the first network entity, a request message to a UDM entity for subscription information. Further, the method includes receiving, by the first network entity, the subscription information comprising the NSSRG information from the UDM entity, wherein the subscription information comprises the NSSRG information comprises the plurality of S-NSSAIs and the plurality of NSSRGs each of which is associated with at least one S-NSSAI from the plurality of S-NSSAIs.

In an embodiment, the method includes determining, by the first network entity or the at least one second network entity, whether a compatible S-NSSAI having same NSSRG information from the plurality of S-NSSAIs used to handle the earlier PDN connection by the first network entity or the at least one second network entity is not found to be allocated. Further, the method includes rejecting by the first network entity, the received PDN connection request.

Accordingly, the embodiment herein is to provide a first network entity for enforcing NSSRG in an EPS. The first network entity includes a NSSRG enforcement controller communicated coupled to a memory and a processor. The NSSRG enforcement controller receives a PDN connection request with an APN from a UE. Further, the NSSRG enforcement controller detects whether any earlier PDN connection for the UE is being handled by the first network entity or at least one second network entity. In an embodiment, when the earlier PDN connection for the UE is handled by the first network entity or the at least one second network entity, the NSSRG enforcement controller applies NSSRG information for the PDN connection, selects the S-NSSAI from a plurality of S-NSSAIs that is compatible to a S-NSSAI having same NSSRG information from the plurality of S-NSSAIs used to handle the earlier PDN connection by the first network entity or the at least one second network entity, and allocates the selected S-NSSAI to the UE to establish the PDN connection with the APN using the allocated S-NSSAI. In another embodiment, when the earlier PDN connection for the UE is not handled with the first network entity or the at least one second network entity, the NSSRG enforcement controller applies NSSRG information for the requested PDN connection, selects the S-NSSAI from a plurality of S-NSSAIs, and allocates the selected S-NSSAI to the UE to establish the PDN connection with the APN using the allocated S-NSSAI.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

according to various embodiments of the disclosure, procedures regarding enforcing network slice simultaneous registration group (NSSRG) in evolved packet system (EPS) can be efficiently enhanced.

### BRIEF DESCRIPTION OF DRAWINGS

The method and the network entity are illustrated in the accompanying drawings, throughout which like reference letters indicate corresponding parts in the various figures. The embodiments herein will be better understood from the following description with reference to the drawings, in which:

FIG. 1 illustrating a scenario of sequence of events where a SMF+PGW-C is not able to enforce NSSRG, according to the prior arts;

FIG. 2 illustrating another scenario of sequence of events where the SMF+PGW-Cs are not able to enforce the NSSRG, according to the prior arts;

FIG. 3 illustrating a scenario of sequence of events takes place where the SMF+PGW-C is able to enforce the NSSRG, according to the embodiments as disclosed herein;

FIG. 4 illustrating another scenario of sequence of events takes place where the SMF+PGW-Cs are able to enforce the NSSRG, according to the embodiments as disclosed herein;

FIG. 5 shows various hardware components of a first network entity, according to the embodiments as disclosed herein; and

FIG. 6 is a flow chart illustrating a method for enforcing the NSSRG in an EPS, according to the embodiments as disclosed herein.

FIG. 7 illustrates a block diagram of a UE according to an embodiment of the disclosure.

FIG. 8 illustrates a block diagram of a network entity according to an embodiment of the disclosure.

### BEST MODE FOR CARRYING OUT THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Below are the some of the abbreviations used in the patent description:
a) AMF—Access and Mobility Management Function
b) UE—User Equipment
c) SMF+PGW-C—Combined GW used for 5GS & EPS interworking
d) 3gpp—3rd Generation Partnership Project
e) NSSAI—Network Slice Selection Assistance Information
f) S-NSSAI—Single-Network Slice Selection Assistance Information
g) NSSRG—Network Slice Simultaneous Registration Group
h) UDM—Unified Data Management
i) HO—Handover

Accordingly, the embodiment herein is to provide a method for enforcing NSSRG in an EPS. The method includes receiving, by a first network entity, a PDN connection request with an APN from a UE. Further, the method includes detecting, by the first network entity, whether any earlier PDN connection for the UE is being handled by the first network entity or at least one second network entity. In an embodiment, when the earlier PDN connection for the UE is handled by the first network entity or the at least one second network entity, the method includes applying NSSRG information for the PDN connection; selecting a S-NSSAI from a plurality of S-NSSAIs that is compatible to a S-NSSAI having same NSSRG information from the plurality of S-NSSAIs used to handle the earlier PDN connection by the first network entity or the at least one second network entity; and allocating the selected S-NSSAI to the UE to establish the PDN connection with the APN using the allocated S-NSSAI. In another embodiment, when the earlier PDN connection for the UE is not handled with the first network entity or the at least one second network entity, the method includes applying NSSRG information for the requested PDN connection; selecting a S-NSSAI from a plurality of S-NSSAIs; and allocating the selected S-NSSAI to the UE to establish the PDN connection with the APN using the allocated S-NSSAI.

Unlike conventional methods, the proposed method can be used to enforce the NSSRG in the EPS for multiple Combined GW used for Evolved Packet Core (EPC) Session Management Function (SMF)+Packet Data Network Gateway (PGW)-Cs. The proposed method addressing the problem when the UE initiated the PDN connections are handled by different SMF+PGW-Cs.

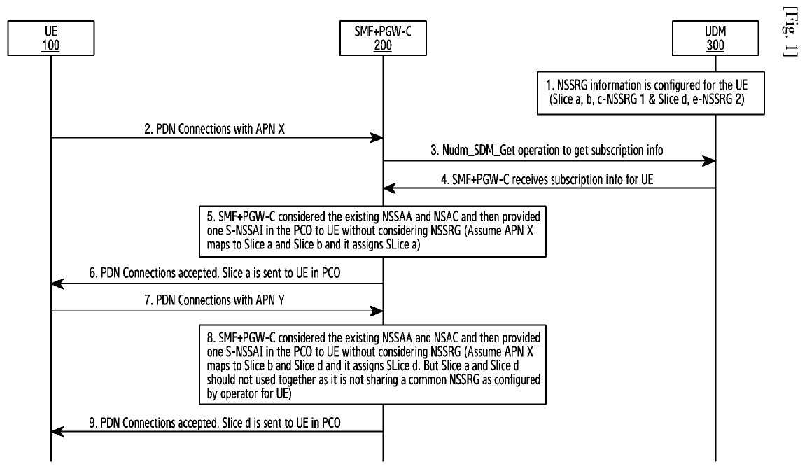

Referring now to the drawings and more particularly to FIGS. 1 through 8, where similar reference characters denote corresponding features consistently throughout the figures, there are shown preferred embodiments.

The 3rd Generation Partnership Project (3GPP) Release 15 introduced a concept of “Network Slicing” which allows telecom service providers deploy an exclusive network for a customer (e.g. mobile virtual network operator (MVNO), Enterprise or the like) or a service (e.g. enhanced Mobile Broadband (eMBB), Ultra Reliable Low Latency Communications (URLLC), massive Machine Type Communications (mMTC) or the like), consisting of multiple network functions designed specifically to support a specialized service. A set of such Network Functions is called “Network Slice”, identified using a Single Network Slice Selection Assistance Information (S-NSSAI) inside the 3GPP network.

These slices are characterized by a set of both standard and proprietary attributes as defined by a “slice template”. A Global System for Mobile Communications (GSMA) defines a “Generic Network Slice Template” (GST) which provides standardized slice attributes for a set of services supported by the 3GPP. One of the attribute defined by the GST is “Simultaneous use of the network slice”. Attribute “Simultaneous use of the network slice” describes whether a network slice can be simultaneously used by a User Equipment (UE) together with other network slices and if so, with which other classes of network slices.

In order to handle this requirement, the 3GPP Release 17 supported the feature. As defined by the 3GPP, the subscription information for the UE may include for each S-NSSAI, Network Slice Simultaneous Registration Group (NSSRG) information constraining which S-NSSAIs can be simultaneously provided to the UE in the Allowed NSSAI. Two S-NSSAIs sharing at least one common NSSRG information can be simultaneously included in the Allowed NSSAI. Otherwise, these S-NSSAIs cannot be included simultaneously in the Allowed NSSAI. The NSSRG information, defining the association of S-NSSAIs to NSSRG, is provided as additional and separate information.

If the optional NSSRG information is not present for the S-NSSAIs of a subscription, and other restrictions do not apply e.g. availability at a specific location, then it is assumed that all the S-NSSAIs in the subscription information can be simultaneously provided to the UE in the Allowed NSSAI. However, if NSSRG information is present in the subscription information, at least one NSSRG shall be associated with each of the S-NSSAIs in the subscription information. At any time, if an Access & Mobility Management Function (AMF) has received subscription information for the UE that includes NSSRG information, the Allowed NSSAI for the UE can only include S-NSSAIs which share a common NSSRG information.

The UE may support the subscription-based restrictions to simultaneous registration of network slice feature. In this case, the UE indicates its support in the Registration Request message in the Initial Registration and the Mobility Registration Update. The supporting AMF stores in the UE context whether the UE has indicated support for the feature.

When the serving PLMN AMF provides the Configured NSSAI to the UE, and the UE has indicated it supports the subscription-based restrictions to simultaneous registration of network slices feature, the AMF also provides the UE with the NSSRG information related to the S-NSSAIs of the HPLMN which are in the mapping information of the Configured NSSAI. The UE which receives the NSSRG values in the network slicing configuration information shall only include in the Requested NSSAI S-NSSAIs that share a common NSSRG information as per the received information.

FIG. 1 is a representation of a sequence of events takes place during PDN Connection Establishment, according to the prior arts.

The UE (100) which supports a NSSRG feature will indicate during an initial registration or mobility registration update so that so that a network will provide NSSRG information to the UE (100). If a Home Public Land Mobile Network (HPLMN) changes NSSRG information in a subscription information for the UE (100), the UDM (or UDM entity) (300) updates the supporting AMF serving the UE (100) with the new NSSRG information and the AMF updates the UE (100) as necessary with network slicing configuration by means of the UE Configuration Update procedure (this may include changes in the Configured NSSAI (and related mapping information) and changes in the Allowed NSSAI as applicable). The UE (100) acknowledges this UE Configuration Update.

These defined procedures ensure that UE (100) is having slices which can be compatible to be used together (having a common NSSRG) and hence there will be no problem for PDU sessions in the 5GS. But in the case of EPS, the UE (100) does not request any slice and it is the network (e.g., SMF+PGW-C or the like) (200) that will allocate an S-NSSAI during the PDN Connections Response. When the UE (100) initiates multiple PDN connections with different APNs which are mapped to different S-NSSAIs, standard has not defined the procedure for enforcing NSSRG. This may lead SMF+PGW-C (200) to assign different slices for different PDN connections which do not share common NSSRG.

Referring to the FIG. 1 considering the conventional methods and systems, illustrates the scenario of the SMF+PGW-C (200) is not enforcing the NSSRG information while assigning the slice for the PDN connections. The method consists of following steps:

At step 1, the NSSRG information is configured for the UE (100) in the subscription profile. (Slice a, Slice b and Slice C shares common NSSRG-1 whereas Slice d and Slice e shares NSSRG-2) and has no configuration like PEI, TAC or some other configuration which will indicate that all the subscribed S-NSSAIs are applicable for the UE (100).

At step 2, as per the existing 3GPP procedure, the UE (100) initiates the PDN connections for APN X which maps to Slice a and Slice b. At step 3, the SMF+PGW-C (200) performs the Nudm_SDM_Get operation to get subscription info from the UDM entity (300).

At step 4, the SMF+PGW-C (200) receives subscription info for the UE (100). At step 5, as per the existing procedures, the SMF+PGW-C (200) considered the existing NSSAA and NSAC and then provided one S-NSSAI in the PCO to the UE (100) without considering NSSRG (Assume APN X maps to Slice a and Slice b and it assigns Slice a).

At step 6, the SMF+PGW-C (200) accepts the PDN connections and sends the slice a in the PCO. At step 7, the UE (100) initiates a new PDN connections with APN Y which maps to Slice b and Slice d. At step 8, the SMF+PGW-C (200) considered the existing NSSAA and NSAC and then provided one S-NSSAI in the PCO to the UE (100) without considering NSSRG (Assume APN Y maps to Slice b and Slice d and it assigns Slice d. But Slice a and Slice d should not use together as it is not sharing a common NSSRG as configured by operator for the UE (100). At step 9, The SMF+PGW-C (200) accepts the PDN connections and provides the Slice d in PCO.

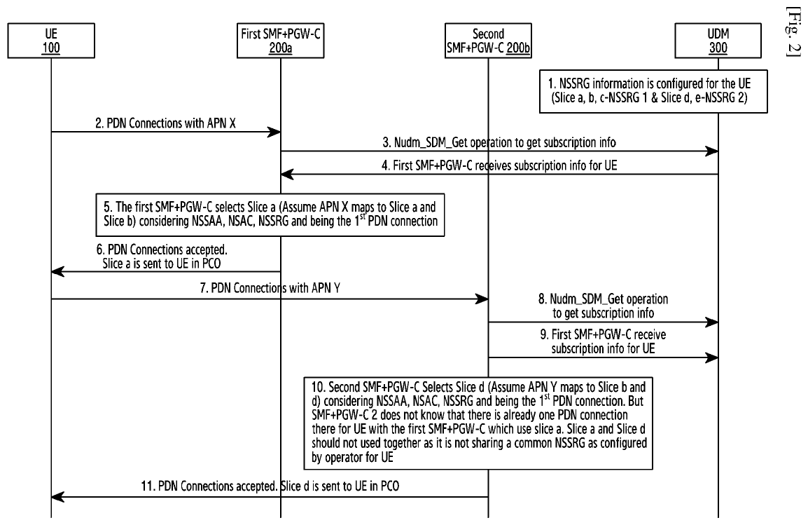

FIG. 2 illustrating a scenario of sequence of events where SMF+PGW-Cs (200a and 200b) are not able to enforce NSSRG, according to the prior arts.

Referring to the conventional methods and systems, the steps are as follows:

At step 1, the NSSRG information is configured for the UE (100) in the Subscription profile (Slice a, Slice b and Slice C shares common NSSRG-1 whereas Slice d and Slice e shares NSSRG-2). At step 2, As per the existing 3GPP procedure UE (100) initiates PDN Connections for APN X which maps to Slice a and Slice b and the request landed at a first SMF+PGW-C (200a).

At step 3, the SMF+PGW-C (200a) performs the Nudm_SDM_Get operation to get subscription info from the UDM entity (300). At step 4, the SMF+PGW-C (200a) receives subscription info for the UE (100).

At step 5, the first SMF+PGW-C (200a) assigns the slice a (Assume APN X maps to Slice a and Slice b) considering NSSAA, NSAC, NSSRG and being the 1st PDN connection.

At step 6, the SMF+PGW-C (200a) accepts the PDN connections and sent the slice a in PCO. At step 7, the UE (100) initiates a new PDN connections with APN Y which maps to Slice b and Slice d and the request is landed at the second SMF+PGW-C (200b).

At step 8, the SMF+PGW-C (200b) performs the Nudm_SDM_Get operation to get subscription info from the UDM entity (300). At step 9, the SMF+PGW-C (200b) receives subscription info for the UE (100).

At step 10, the SMF+PGW-C (200b) selects the slice d (Assume APN Y maps to Slice b and d) considering NSSAA, NSAC, NSSRG and being the 1st PDN connection. But the SMF+PGW-C (200b) does not know that there is already one PDN connection there for UE with the first SMF+PGW-C (200a) which use slice a. Slice a and Slice d should not use together as it is not sharing a common NSSRG as configured by operator for the UE (100). At step 11, the SMF+PGW-C (200b) accepts the PDN connections and provides the Slice d in PCO.

Some of the prior art address the enforcing NSSRG for multiple PDN connections when handled by same SMF+PGW-C (200). The proposed method is addressing the problem when the UE (100) initiated PDN connections are handled by different SMF+PGW-Cs (200a and 200b). Whenever SMF+PGW-C (200) receives one PDN connection as per existing procedures (Nudm_SDM_Get) it retrieves the subscription information from the UDM entity (300). It is proposed that the SMF+PGW-C (200) do Nudm_UECM_Get operation as well to receive any established PDN connections and corresponding S-NSSAI. With this solution, during subsequent PDN connections, the SMF+PGW-C (200) will be able to identify the used slice for the already established PDU session and hence will apply the NSSRG before assigning the slice.

Unlike to the conventional methods and systems, the proposed method is addressing the problem explained which occurs during multiple PDN Connections initiated by the UE (100) by defining the SMF+PGW-C behaviour. It is proposed that when the SMF+PGW-C (200) receives the PDN connections from UE (100) and the APN map to multiple S-NSSAIs, it consider NSSRG information apart from the existing NSSAA (Network Slice Specific Authentication and Authorization) and NSAC (Network Slice Admission Control) information. When subsequent PDN connections received at the SMF+PGW-C (200) and the APN maps to different S-NSSAIs than the previously used S-NSSAI for existing PDN connection then it is proposed that the SMF+PGW-C (200) select one S-NSSAI which is compatible with the previously used S-NSSAI (shares a common NSSRG value). Also, if the SMF+PGW-C (200) are not able to select a suitable slice then it may reject the PDN Connections.

If the establishment of a new PDN Connections is with a different SMF+PGW-C from the SMF+PGW-C used for already existing PDN connection, then it may fetch from the UDM entity (300) about any existing PDN connection and corresponding S-NSSAI for the UE (100). If it receives the response from the UDM entity (300) about the existing PDN connection and corresponding S-NSSAI then, the SMF+PGW-C (200) may select one S-NSSAI which shares a common NSSRG with the S-NSSAI of existing PDN connection. But if the SMF+PGW-C (200) is not able to identify the S-NSSAI used for existing PDN connections, in this SMF+PGW-C (200) may reject the PDN connections. But based on the operator policy if SMF+PGW-C accept the PDN connections then during HO from the EPS to the 5GS, the AMF and/or the NSSF will remove one of the incompatible (slice which does not share the common NSSRG) from the allowed S-NSSAIs and release the corresponding session (which means all the PDN Connections will not be successfully transferred to the 5GS). It is proposed that the AMF and/or the NSSF may be based on policy (network policy, operator policy or priority among slices etc.) will select one of the incompatible slices while considering/constructing the allowed S-NSSAIs.

Referring to the FIG. 3 considering the proposed method illustrating the scenario of SMF+PGW-C (200) is enforcing NSSRG information while assigning the slice for the PDN connections. The method consists of following steps:

At step 1, the NSSRG information is configured for the UE (100) in the subscription profile. In an example, the Slice a, Slice b and Slice C shares common NSSRG-1 whereas Slice d and Slice e shares NSSRG-2) and has no configuration like PEI, TAC or some other configuration which will indicate that all the subscribed S-NSSAIs are applicable for the UE (100).

At step 2, as per the existing 3GPP procedure, the UE (100) initiates PDN Connections for APN X which maps to Slice a and Slice b. At step 3, the SMF+PGW-C (200) performs the Nudm_SDM_Get operation to get subscription info from the UDM entity (300). At step 4, the SMF+PGW-C (200) receives subscription info for the UE (100).

At step 5, the SMF+PGW-C (200) is proposed to check whether any existing PDN connection is there or not. As this is the 1st PDN connections for the UE (100) it is proposed that the SMF+PGW-C (200) consider NSSRG information along with existing NSSAA and NSAC and then provided one S-NSSAI in the PCO to (Assume APN X maps to Slice a and Slice b and it assigns Slice a.

At step 6, SMF+PGW-C (200) accepts the PDN connections and sent the slice a in PCO. At step 7, The UE (100) initiates a new PDN connections with APN Y which maps to Slice b and Slice d.

At step 8, the SMF+PGW-C (200) is proposed to check whether any existing PDN connection is there or not. As this is the 2nd PDN connections for the UE it is proposed that SMF+PGW-C consider NSSRG information along with existing NSSAA and NSAC and then provide one S-NSSAI sharing common NSSRG to the slice used for the existing PDN connection in the PCO (Assume APN Y maps to Slice b and Slice d and it assigns Slice b as it shares common NSSRG to the slice a which is used for the 1st PDN connection. At step 9, the SMF+PGW-C (200) accepts the PDN connections and provides the Slice b in PCO.

In an embodiment, if the SMF+PGW-C (200) are not able to select the slice which shares the common NSSRG with the slice from the existing PDN Connections then it may reject the PDN connections.

In an embodiment, if the establishment of a new PDN Connections is with a different SMF+PGW-C from the SMF+PGW-C used for already existing PDN connection, then it may fetch from the UDM entity (300) about any existing PDN connection and corresponding S-NSSAI for the UE (100). If it receives the response from the UDM entity (300) about the existing PDN connection and corresponding S-NSSAI then, the SMF+PGW-C (200) may select one S-NSSAI which shares the common NSSRG with the S-NSSAI of existing PDN connection.

In an embodiment, if the SMF+PGW-C (200) is not able to identify during the subsequent PDN connections about the previously used slice for the existing PDN connections then it may reject the PDN connections. But based on the operator policy if SMF+PGW-C accept the PDN connections but during HO from the EPS to the 5GS, the AMF and/or the NSSF may remove one of the incompatible slice from the allowed S-NSSAIs. It may also release the corresponding PDU sessions.

In an embodiment, based on policy (network, operator policy etc) or based on priority among slices, the AMF and/or the NSSF identify one of the slice to remove from the allowed S-NSSAIs while doing HO from the EPS to the 5GS.

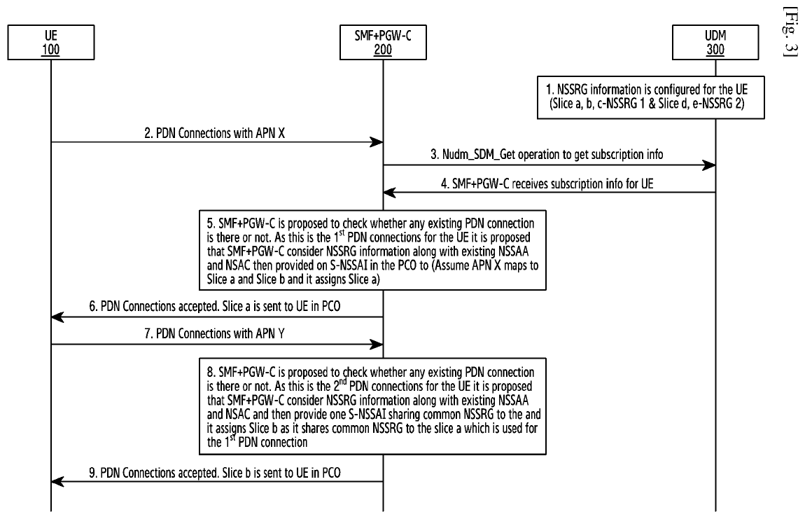

FIG. 4 illustrating a scenario of sequence of events takes place where SMF+PGW-Cs (200a and 200b) are able to enforce NSSRG, according to the embodiments as disclosed herein.

Referring to the FIG. 4 considering the proposed method, the steps are as follows:

At step 1, the NSSRG information is configured for the UE (100) in the subscription profile. In an example, the Slice a, Slice b and Slice C shares common NSSRG-1 whereas Slice d and Slice e shares NSSRG-2. At step 2, as per the existing 3GPP procedure, the UE (100) initiates the PDN Connections for APN X which maps to Slice a and Slice b and the request landed at the first SMF+PGW-C (200a).

At step 3, the SMF+PGW-C (200a) performs the Nudm_SDM_Get operation to get subscription info from the UDM entity (300). At step 4, the SMF+PGW-C (200a) receives subscription info for the UE (100).

At step 5, the first SMF+PGW-C (200a) finds that this is the 1st PDN connection but it is proposed to check with the UDM entity (300) whether they may be PDN connections there for the UE (100) with other SMF+PGW-C.

At step 6, the first SMF+PGW-C (200a) is proposed to do the Nudm_UECM_Get operation to know about any already established PDU session and corresponding S-NSSAI. At step 7, as this was the first PDN connection initiated by the UE (100), there was no established PDU session which was stored in UDM entity (300). Hence, the UDM entity (300) responded with no PDU session and the S-NSSAI.

At step 8, the first SMF+PGW-C (200a) finds that this is the 1st PDN connection and hence considering NSAC, NSSAA and NSSRG it assigns slice a (Assume APN X maps to Slice a and Slice b)

At step 9a, the first SMF+PGW-C (200a) accepts the PDN connections and sent the slice a in the PCO. At step 9b, the SMF+PGW-C (200a) sends the message to the UDM entity (300) using the Nudm_UECM_Registration service operation to store the PDU session ID and associated/allocated slice for the established PDN connection. At step 10, the UE (100) initiates a new PDN connections with APN Y which maps to Slice b and Slice d and the request is landed at the second SMF+PGW-C (200b). At step 11, the SMF+PGW-C (200b) performs the Nudm_SDM_Get operation to get subscription info from the UDM entity (300). At step 12, the SMF+PGW-C (200b) receives subscription info for the UE (100).

At step 13, the first SMF+PGW-C (200a) finds that this is the 1st PDN connection but it is proposed to check with the UDM entity (300) whether they may be PDN connections there for UE (100) with other SMF+PGW-C

At step 14, the first SMF+PGW-C (200a) performs the Nudm_UECM_Get operation (Get PDU session ID and corresponding S-NSSAI) with the UDM entity (300). At step 15, the UDM (300) will send the PDU session ID and associated slice for the earlier established PDN connection to SMF+PGW-C (200a).

At step 16, the second SMF+PGW-C (200b) selects the Slice b (Assume APN Y maps to Slice b and d) because it received the info from the UDM entity (300) that already one PDN is there (slice b shares common NSSRG with the slice a which is used for the 1st PDN connection cannot be used together with slice a. At step 17, the second SMF+PGW-C (200b) will send the Slice b in PCO to the UE (100) and the PDN connections is accepted.

In an embodiment, the SMF+PGW-C (200) does Nudm_UECM_get operation to know about the already established PDN connection and corresponding S-NSSAI.

In an embodiment, the SMF+PGW-C (200) apply the NSSRG and assign slice which is compatible to the slice while was already allocated by different SMF+PGW-C and used for the established PDN connection.

In an embodiment, if the SMF+PGW-C (200) is not able to select a slice which shares a common NSSRG with the slice from the existing PDN Connections handled by different SMF+PGW-C then it may reject the PDN connections.

In an embodiment, if the SMF+PGW-C is already handling one PDN connection for the UE (100) (it means SM context has NSSRG information) then for subsequent PDN connection same SMF+PGW-C is not needed to do Nudm_UECM_Get operation. Because any number of PDN connections UE (100) may initiate, all the SMF+PGW-C will be able to allocate the slice which shares same NSSRG information from the 1st established PDN connection.

In an embodiment, when the NSSRG is deployed by the operator the SMF+PGW-C updates or stores the PDU session IDs and S-NSSAI to the UDM entity (300) when PDN connection is successfully established and the UDM entity (300) removes this information when the SMF+PGW-C deregister itself from the UDM entity (300) after PDN connection is released for the UE (100).

In an embodiment, if the UE (100) initiates two PDN connections simultaneously and the request is handled by different SMF+PGW-Cs then both SMF+PGW-Cs connections may not be able to allocate slices which will be compatible with each other but during HO from the EPS to the 5GS, the AMF and/or the NSSF may remove one of the incompatible slice from the allowed S-NSSAIs. It may also release the corresponding PDU sessions.

In an embodiment, based on policy (network, operator policy etc) or based on priority among slices, the AMF and/or the NSSF identify one of the slice to remove from the allowed S-NSSAIs while doing HO from the EPS to the 5GS.

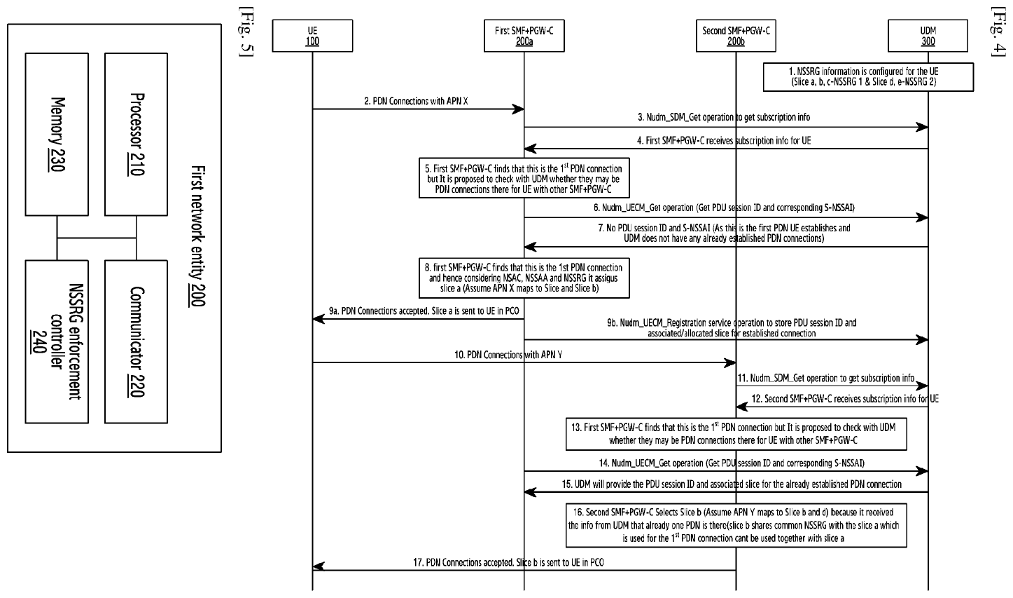

FIG. 5 shows various hardware components of the first network entity (200), according to the embodiments as disclosed herein. The first network entity (200) can be the first SMF+PGW-C (200a) or the second SMF+PGW-C (200b). In an embodiment, the first network entity (200) includes a processor (210), a communicator (220), a memory (230) and a NSSRG enforcement controller (240). The processor (210) is coupled with the communicator (220), the memory (230) and the NSSRG enforcement controller (240).

Consider, the first network entity (200a) is the SMF Packet Data Network Gateway-Controller and the second network entity (200b) is the second SMF Packet Data Network Gateway-Controller. The NSSRG enforcement controller (240) receives the PDN connection request with the APN from the UE (100). Further, the NSSRG enforcement controller (240) detects whether any earlier PDN connection for the UE (100) is being handled by the first network entity (200a) or the at least one second network entity (200b). In an embodiment, the NSSRG enforcement controller (240) checks whether the earlier PDN connection of the UE (100) is associated with the first network entity (200a) based on a session management context stored at the first network entity (200a). Further, the NSSRG enforcement controller (240) determines that the earlier PDN connection of the UE (100) is not associated with the first network entity (200a). Further, the NSSRG enforcement controller (240) sends the request message to the UDM entity (300) for PDN connection information of the UE (100) associated with the at least one second network entity (200b). Further, the NSSRG enforcement controller (240) receives the PDN connection information from the UDM entity (300) for PDN connection information of the UE (100) associated with the at least one second network entity (200b). Further, the NSSRG enforcement controller (240) detects whether the earlier PDN connection of the UE (100) is associated with the at least one second network entity (200b) when the received PDN connection information comprises PDU session identifier associated with the UE (100) and corresponding S-NSSAI used by the at least one second network entity (200b) to establish the earlier PDN connection with the UE (100).

In an embodiment, when the earlier PDN connection for the UE (100) is handled by the first network entity (200a) or the at least one second network entity (200b), the NSSRG enforcement controller (240) applies the NSSRG information for the PDN connection and selects the S-NSSAI from the plurality of S-NSSAIs that is compatible to a S-NSSAI having same NSSRG information from the plurality of S-NSSAIs used to handle the earlier PDN connection by the first network entity (200a) or the at least one second network entity (200b). Further, the NSSRG enforcement controller (240) allocates the selected S-NSSAI to the UE (100) to establish the PDN connection with the APN using the allocated S-NSSAI. The selected S-NSSAI is associated with same NSSRG information from a plurality of NSSRGs provided in the NSSRG information. In an embodiment, the selected S-NSSAI is allocated to the UE (100) by sending the NAS message comprising the selected S-NSSAI associated to the UE (100) to establish the PDN connection with the APN using the allocated S-NSSAI.

In another embodiment, when the earlier PDN connection for the UE (100) is not handled with the first network entity (200a) or the at least one second network entity (200b), the NSSRG enforcement controller (240) applies the NSSRG information for the requested PDN connection and selects the S-NSSAI from the plurality of S-NSSAIs. Further, the NSSRG enforcement controller (240) allocates the selected S-NSSAI to the UE (100) to establish the PDN connection with the APN using the allocated S-NSSAI.

In an embodiment, further, the NSSRG enforcement controller (240) sends the PDU session ID and associated S-NSSAI associated with the PDN connection to the UDM entity (300) after PDN connection is established successfully.

In an embodiment, further, the NSSRG enforcement controller (240) sends the request message to the UDM entity (300) for subscription information. Further, the NSSRG enforcement controller (240) receives the subscription information comprising the NSSRG information from the UDM entity (300), wherein the subscription information comprises the NSSRG information comprises the plurality of S-NSSAIs and the plurality of NSSRGs each of which is associated with at least one S-NSSAI from the plurality of S-NSSAIs.

In an embodiment, further, the NSSRG enforcement controller (240) determines whether a compatible S-NSSAI having same NSSRG information from the plurality of S-NSSAIs used to handle the earlier PDN connection by the first network entity (200a) or the at least one second network entity (200b) is not found to be allocated. Further, the NSSRG enforcement controller (240) rejects the received PDN connection request.

The NSSRG enforcement controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 5 shows various hardware components of the first network entity (200) but it is to be understood that other embodiments are not limited thereon. In other embodiments, the first network entity (200) may include less or more number of components. Further, the labels or names of the components are used only for illustrative purpose and does not limit the scope of the invention. One or more components can be combined together to perform same or substantially similar function in the first network entity (200).

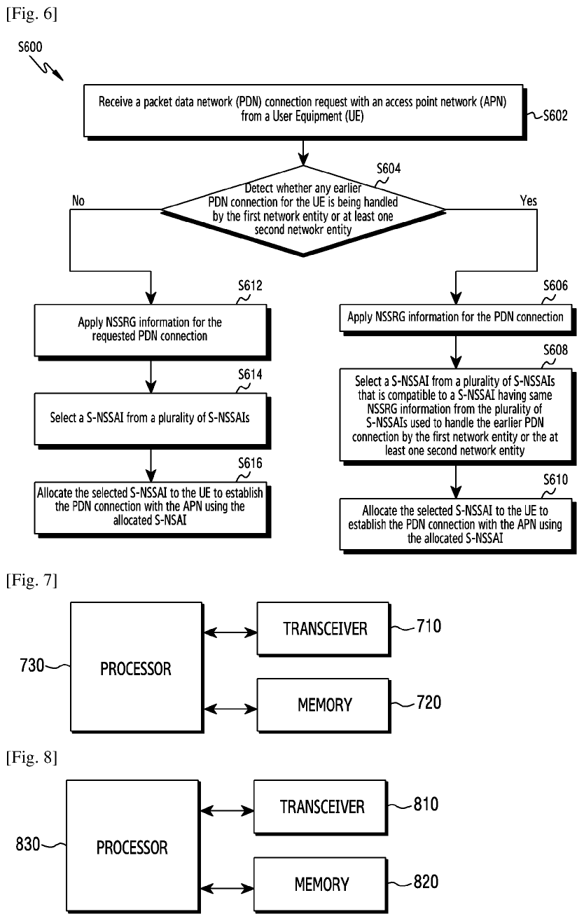

FIG. 6 is a flow chart (S600) illustrating a method for enforcing the NSSRG in the EPS, according to the embodiments as disclosed herein. The operations (S602-S616) are handled by the NSSRG enforcement controller (240).

At S602, the method includes receiving the PDN connection request with the APN from the UE (100). At S604, the method includes detecting whether any earlier PDN connection for the UE (100) is being handled by the first network entity (200a) or the at least one second network entity (200b).

When the earlier PDN connection for the UE (100) is handled by the first network entity (200a) or the at least one second network entity (200b), at S606, the method includes applying the NSSRG information for the PDN connection. At S608, the method includes selecting the S-NSSAI from the plurality of S-NSSAIs that is compatible to the S-NSSAI having same NSSRG information from the plurality of S-NSSAIs used to handle the earlier PDN connection by the first network entity (200a) or the at least one second network entity (200b). At S610, the method includes allocating the selected S-NSSAI to the UE (100) to establish the PDN connection with the APN using the allocated S-NSSAI.

When the earlier PDN connection for the UE (100) is not handled with the first network entity (200a) or the at least one second network entity (200b), at S612, the method includes applying NSSRG information for the requested PDN connection. At S614, the method includes selecting the S-NSSAI from the plurality of S-NSSAIs. At S616, the method includes allocating the selected S-NSSAI to the UE (100) to establish the PDN connection with the APN using the allocated S-NSSAI.

FIG. 7 illustrates a block diagram of a UE, according to embodiments of the present disclosure.

As shown in FIG. 7 is, the UE of the present disclosure may include a transceiver 710, a memory 720, and a processor (or, a controller) 730. The transceiver 710, the memory 720, and the processor (or controller) 730 of the UE may operate according to a communication method of the UE described above. However, the components of the UE are not limited thereto. For example, the UE may include more or fewer components than those described in FIG. 7. In addition, the processor (or controller) 730, the transceiver 710, and the memory 720 may be implemented as a single chip. Also, the processor (or controller) 730 may include at least one processor.

The transceiver 710 collectively refers to a UE receiver and a UE transmitter, and may transmit/receive a signal to/from another UE, and/or a core network function(s) (or entity(s)). The signal transmitted or received to or from the UE may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor (or controller) 730, a signal through a wireless channel, and transmit a signal output from the processor (or controller) 730 through the wireless channel.

The memory 720 may store a program and data required for operations of the UE. Also, the memory 720 may store control information or data included in a signal obtained by the UE. The memory 720 may be a storage medium, such as ROM, RAM, a hard disk, a CD-ROM, and a DVD, or a combination of storage media.

The processor (or controller) 730 may control a series of processes such that the UE operates as described above. For example, the processor (or controller) 730 may receive a data signal and/or a control signal, and the processor (or controller) 730 may determine a result of receiving the signal transmitted by the terminal and/or the core network function.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

FIG. 8 illustrates a block diagram of a network entity, according to embodiments of the present disclosure.

As shown in FIG. 8 is, the network entity of the present disclosure may include a transceiver 810, a memory 820, and a processor (or, a controller) 830. The transceiver 810, the memory 820, and the processor (or controller) 830 of the network entity may operate according to a communication method of the network entity described above. However, the components of the network entity are not limited thereto. For example, the network entity may include more or fewer components than those described in FIG. 8. In addition, the processor (or controller) 830, the transceiver 810, and the memory 820 may be implemented as a single chip. Also, the processor (or controller) 830 may include at least one processor. FIG. 8 includes to the example of the first network entity of FIG. 5.

The transceiver 810 collectively refers to a network entity receiver and a network entity transmitter, and may transmit/receive a signal to/from a UE and/or another core network function(s) (or entity(s)). The signal transmitted or received to or from the network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor (or controller) 830, a signal through a wireless channel, and transmit a signal output from the processor (or controller) 830 through the wireless channel.

The memory 820 may store a program and data required for operations of the network entity. Also, the memory 820 may store control information or data included in a signal obtained by the network entity. The memory 820 may be a storage medium, such as ROM, RAM, a hard disk, a CD-ROM, and a DVD, or a combination of storage media.

The processor (or controller) 830 may control a series of processes such that the network entity operates as described above. For example, the processor (or controller) 830 may receive a data signal and/or a control signal, and the processor (or controller) 830 may determine a result of receiving the signal transmitted by the terminal and/or the core network function.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The various actions, acts, blocks, steps, or the like in the flow chart (S600) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a first network entity in a mobile communication system, the method comprising:
receiving a packet data network (PDN) connection request with an access point network (APN) from a user equipment (UE), for enforcing network slice simultaneous registration group (NSSRG) in an evolved packet system (EPS);
detecting whether any earlier PDN connection for the UE is being handled by the first network entity or at least one second network entity;
performing one of:
a) when the earlier PDN connection for the UE is handled by the first network entity or the at least one second network entity, applying nssrg information for the pdn connection; selecting a single-network slice selection assistance information (S-NSSAI) from a plurality of S-NSSAIs that is compatible to a S-NSSAI having same NSSRG information from the plurality of S-NSSAIs used to handle the earlier PDN connection by the first network entity or the at least one second network entity; and allocating the selected S-NSSAI to the UE to establish the PDN connection with the APN using the allocated S-NSSAI; and
b) when the earlier PDN connection for the UE is not handled with the first network entity or the at least one second network entity, applying NSSRG information for the requested PDN connection; selecting a S-NSSAI from a plurality of S-NSSAIs; and allocating the selected S-NSSAI to the UE to establish the PDN connection with the APN using the allocated S-NSSAI.

2. The method for claim 1, further comprising sending, by at least one of the first network entity and the at least one second network entity, the PDU session ID and associated S-NSSAI associated with the PDN connection to a unified data management (UDM) entity after PDN connection is established successfully.

3. The method for claim 1,
wherein the first network entity is a session management function (SMF) packet data network gateway-controller and the second network entity is a second SMF packet data network gateway-controller.

4. The method for claim 1, wherein the selected S-NSSAI is associated with same NSSRG information from a plurality of NSSRGs provided in the NSSRG information.

5. The method for claim 1,
wherein allocating the selected S-NSSAI to the UE comprises sending a NAS message comprising the selected S-NSSAI associated to the UE to establish the PDN connection with the APN using the allocated S-NSSAI.

6. The method for claim 1, wherein detecting whether any of the earlier PDN connection for the UE is handled by the first network entity or the at least one second network entity comprises:
checking whether the earlier PDN connection of the UE is associated with the first network entity based on a session management context stored at the first network entity;
determining that the earlier PDN connection of the UE is not associated with the first network entity;
sending a request message to a UDM entity for PDN connection information of the UE associated with the at least one second network entity;
receiving the PDN connection information from the UDM entity for PDN connection information of the UE associated with the at least one second network entity; and
detecting whether the earlier PDN connection of the UE is associated with the at least one second network entity when the received PDN connection information comprises PDU session identifier associated with the UE and corresponding S-NSSAI used by the at least one second network entity to establish the earlier PDN connection with the UE.

7. The method for claim 1, further comprising:
sending a request message to a UDM entity for subscription information; and
receiving the subscription information comprising the NSSRG information from the UDM entity, wherein the subscription information comprises the NSSRG information comprises the plurality of S-NSSAIs and the plurality of NSSRGs each of which is associated with at least one S-NSSAI from the plurality of S-NSSAIs.

8. The method for claim 1, further comprising:
determining whether a compatible S-NSSAI having same NSSRG information from the plurality of S-NSSAIs used to handle the earlier PDN connection by the first network entity or the at least one second network entity is not found to be allocated, and
rejecting the received PDN connection request.

9. A first network entity in a mobile communication system, wherein the first network entity comprises:
a transceiver; and
a controller coupled with to the transceiver and configured to:
receive a packet data network (PDN) connection request with an access point network (APN) from a user equipment (UE) for enforcing network slice simultaneous registration group (NSSRG) in an evolved packet system (EPS);
detect whether any earlier PDN connection for the UE is being handled by the first network entity or at least one second network entity;
perform one of:
a) when the earlier PDN connection for the UE is handled by the first network entity or the at least one second network entity, apply NSSRG information for the PDN connection; select a single-network slice selection assistance information (S-NSSAI) from a plurality of S-NSSAIs that is compatible to a S-NSSAI having same NSSRG information from the plurality of S-NSSAIs used to handle the earlier PDN connection by the first network entity or the at least one second network entity; and allocate the selected S-NSSAI to the UE to establish the PDN connection with the APN using the allocated S-NSSAI; and
b) when the earlier PDN connection for the UE is not handled with the first network entity or the at least one second network entity, apply NSSRG information for the requested PDN connection; select a S-NSSAI from a plurality of S-NSSAIs; and allocate the selected S-NSSAI to the UE to establish the PDN connection with the APN using the allocated S-NSSAI.

10. The first network entity for claim 9, wherein the controller is configured to send the PDU session ID and associated S-NSSAI associated with the PDN connection to a unified data management (UDM) entity after PDN connection is established successfully.

11. The first network entity for claim 9,
wherein the first network entity is a session management function (SMF) packet data network gateway-controller and the second network entity is a second SMF packet data network gateway-controller.

12. The first network entity for claim 9,
wherein the selected S-NSSAI is associated with same NSSRG information from a plurality of NSSRGs provided in the NSSRG information.

13. The first network entity for claim 9, wherein, in order to allocate the selected S-NSSAI to the UE, the controller is configured to send a NAS message comprising the selected S-NSSAI associated to the UE to establish the PDN connection with the APN using the allocated S-NSSAI.

14. The first network entity for claim 9, wherein, in order to detect whether any of the earlier PDN connection for the UE is handled by the first network entity or the at least one second network entity, the controller is configured to:
check whether the earlier PDN connection of the UE is associated with the first network entity based on a session management context stored at the first network entity;
determine that the earlier PDN connection of the UE is not associated with the first network entity;
send a request message to a UDM entity for PDN connection information of the UE associated with the at least one second network entity;
receive the PDN connection information from the UDM entity for PDN connection information of the UE associated with the at least one second network entity; and
detect whether the earlier PDN connection of the UE is associated with the at least one second network entity when the received PDN connection information comprises PDU session identifier associated with the UE and corresponding S-NSSAI used by the at least one second network entity to establish the earlier PDN connection with the UE.

15. The first network entity for claim 9, wherein the controller is configured to:
send a request message to a UDM entity for subscription information; and
receive the subscription information comprising the NSSRG information from the UDM entity, wherein the subscription information comprises the NSSRG information comprises the plurality of S-NSSAIs and the plurality of NSSRGs each of which is associated with at least one S-NSSAI from the plurality of S-NSSAIs.
